(19) United States
(12) Patent Application Publication
(10) Pub. No.: US 2006/0085851 A1
(43) Pub. Date: Apr. 20, 2006

(54) Systems, Methods, and Computer Readable Medium for Avoiding a Network Address Collision

(75) Inventors: Ivan M. Heninger, Selma, NC (US); John Damon Kari, Coeur d'Alene, ID (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/711,940

(22) Filed: Oct. 14, 2004

(51) Int. Cl. G06F 15/16; G06F 17/00; G06F 9/00

(52) U.S. Cl. 726/15

(57) ABSTRACT

Techniques are provided for avoiding a network address collision when a computer tries to access a target network while being connected to an originating network. To this end, a computer requests a network address for operating in the target network. Upon receiving the requested network address, it is determined whether a conflict exists between the network address for operating in the originating network and the requested network address. If a conflict occurs, a different network address is determined which is different from the requested network address. Upon receipt of the different network address, the computer utilizes the different network address to access the target network, avoiding conflict with the network address for operating in the originating network.

### FIELD OF THE INVENTION

The present invention generally relates to systems, methods, and computer readable media for avoiding a network address collision, and more particularly, to advantageous systems, methods, and computer program products for avoiding network address collisions such as those experienced by a computer device disposed in multiple active networks.

### BACKGROUND OF THE INVENTION

Today's roaming employee may need access to corporate information and applications stored on his or her employer's private communication networks from a variety of places such as a client's office, the employee's home, an off-site meeting location, a coffee house, or the like. The roaming employee may be a salesperson requiring information on the latest pre-released product when making a sales call. Or perhaps, the roaming employee needs to collaborate with another roaming employee in developing a sales pitch. IBM's Websphere Everyplace Connection Manager(WECM) is one software application which enables a mobile device to access a remote private network and allows the mobile device on a local area network (LAN) to access a wide area network (WAN). Applications like IBM's WECM typically utilize a virtual private network (VPN) to establish a communication connection between the mobile device and resources found on the employer's private communication network.

A virtual private network is one way in which remote offices or individual users can employ a public telecommunication infrastructure, such as the Internet or a public switched telephone network (PSTN) to obtain secure access to their organization's network. A virtual private network can be contrasted with an expensive system of owned or leased lines that can only be used by one organization. The goal of a VPN is to provide the organization with the same capabilities of the expensive system of owned or leased lines, but at a much lower cost.

A VPN can be established over a point-to-point network or over a peer-to-peer network. In a point-to-point network, a point-to-point protocol (PPP) is typically used to assign a network address to a VPN client. In a peer-to-peer network, a dynamic host configuration protocol (DHCP) is typically used to assign a network address to the VPN client.

During the establishment of a session with a target network, a VPN server assigns a network address imbedded in an internet protocol (IP) address to a VPN client. In typical operations where the VPN client itself is not on a network, the VPN client utilizes the assigned IP address to access information resources in the target network. However, as VPN clients are becoming more prevalent in today's mobile workforce environment and as today's mobile computers are accessing VPNs from existing networks such as those found at local coffee shops and the like, mobile computer devices, on which VPN clients run, are required to operate with multiple IP addresses.

In the past, only routers or bridges typically required multiple network addresses to communicate over multiple networks. Typically routers and bridges are not mobile so that their network addresses normally are statically defined. Unlike routers and bridges, today's mobile computer devices may be connecting to both a local wireless network and a remote VPN network where both networks provide either automatic or dynamic network addresses.

In either a PPP protocol, DHCP protocol, or priority protocol, when a VPN client connected to a pre-existing network attempts to establish a session with a target network, a VPN server of the target network may attempt to assign a network address to the VPN client which is already being utilized by the computer device running the VPN client in the originating network. As a result, a collision of network addresses occurs and typically renders both networks inaccessible by the computer device upon which the VPN client runs. If the pre-existing network is managed by the same managing entity that manages the target network, the addressing scheme would be known by the managing entity which could then allocate network addresses according to the known addressing scheme to avoid collision because the managing entity has knowledge of each network. However, where the networks are managed by different managing networks, the addressing scheme of both networks is not known by a single entity such that collisions are more likely to occur.

### SUMMARY OF THE INVENTION

Among its several aspects, due to the potential collision of network addresses offered by a server computer, the present invention recognizes that a need exists for providing a mechanism for eliminating or reducing the risk of a client computer attempting to utilize the same network address when communicating on multiple communication networks. The present invention also recognizes that systems, methods, and computer readable media are needed to address the risk of a potential collision of network addresses. Further, the present invention recognizes the value of eliminating the risk of the client computer attempting to utilize the same network address when communicating on multiple communication networks.

Among its several aspects, the present invention provides a system, method, and computer readable media for avoiding a network address collision when a computer tries to access a target network while being connected to an originating network. To this end, the method includes identifying a computer on the originating network with a first address. The first address includes a first network address. The computer subsequently requests a connection to the target network. A second address having a second network address is returned to the computer in response to the connection request. The first and second network addresses are compared to determine whether a conflict exists. If so, the second network address is reported to be in conflict. By way of example, another network address is requested and compared until a non-conflicting network address is obtained so that the conflict is avoided.

A more complete understanding of the present invention, as well as further features and advantages of the invention, will be apparent from the following Detailed Description and the accompanying drawings.

### BRIEF DESCRIPTION OF THE DRAWINGS

FIG. 1 is an illustration of an exemplary network environment in which the present invention may be advantageously employed.

FIG. 2 is an exemplary flow diagram illustrating the flow of messages in the network environment of FIG. 1 to receive an internet protocol (IP) address for a VPN session in accordance with the present invention.

FIG. 3A is a table containing an exemplary IP address and network mask received by the address requestor in FIG. 2 for use in the originating network of FIG. 1.

FIG. 3B is a table containing an exemplary IP address and network mask carried in address acknowledgement sent from remote address server of FIG. 2.

FIG. 3C is a table containing a second exemplary IP address and network mask carried in the second address acknowledgement from the remote address server of FIG. 2.

FIG. 4 is a flow chart illustrating a method of avoiding a network address collision in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as methods, systems, or computer readable media. Accordingly, the present invention may take the form of a hardware embodiment, a software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, flash memories, magnetic storage devices, or the like.

Computer program code or “code” for carrying out operations according to the present invention may be written in an object oriented programming language such as JAVA®, Smalltalk, JavaScript®, Visual Basic®, TSQL, Perl, C, C++ or in various other programming languages. Software embodiments of the present invention do not depend on implementation with a particular programming language. Portions of the code may execute entirely on one or more systems utilized by an intermediary server.

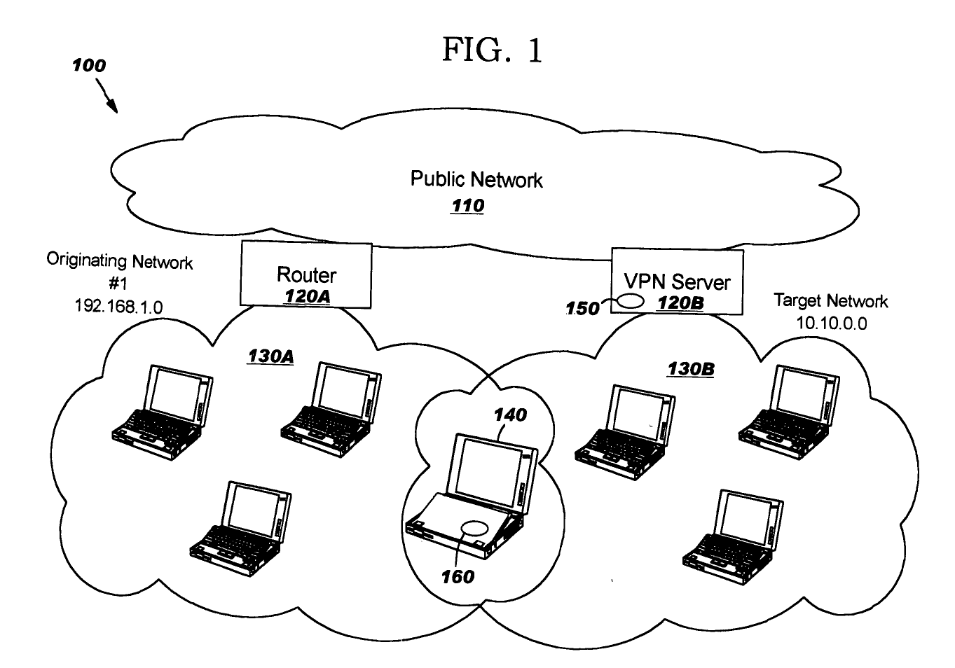

The code may execute partly on a server and partly on a client within a client device, or it may execute entirely on one or more servers or at a proxy server at an intermediate point in a communications network. Regarding the former scenario, FIG. 1 is an illustration of an exemplary system 100 in which the present invention may be advantageously employed. The system 100 includes a client device 140 such as a laptop computer, handheld computer, or any other computer based device which contains a central processing unit (CPU), memory, and can execute computer program code. The client device 140 may be connected through a wireless or wired connection to a router 120A over a private network 130A such as a LAN, WAN or other intranet, or the connection may be made through the Internet via an Internet service provider (ISP).

In the example shown, the client device 140 may be operated to connect to second private network 130B such as a LAN, WAN or other intranet through a wireless or wired connection to server 120B. The servers 120A and 120B provide a known network address translation (NAT) function and perform network address assignment protocol such as DHCP, PPP, or the like. Through the network address assignment protocol, the servers 120A and 120B provide network addresses for computers to logically connect to networks 130A and 130B, respectively. Servers 120A and 120B communicate over the public network 110 such as the Internet or public switched telephone network (PSTN).

For the exemplary embodiment depicted in FIG. 1, server 120B is a VPN server. The VPN server provides additional security and authorization functions before allowing a client device 140 to connect to its network 130B. In the preferred embodiment of the present invention, the client device executes client code 160 to request access to network 130B in accordance with the teachings of the present invention and the VPN server 120B executes server code 150 to provide access to network 130B in accordance with the teachings of the present invention. Examples of client code 160 would include modified versions of Nortel's Contivity client, Cisco's VPN client, and IBM's Websphere Everywhere Connection Manager client, and the like modified so as to operate in accordance with the teachings of the present invention. Examples of server code 150 would include modified versions of Nortel's Contivity server, Cisco's VPN server, and IBM's Websphere Everywhere Connection Manager server, or the like as discussed in further detail below. Throughout the example of the present discussion, it is understood that the term “originating network” refers to network 130A and the term “target network” refers to network 130B.

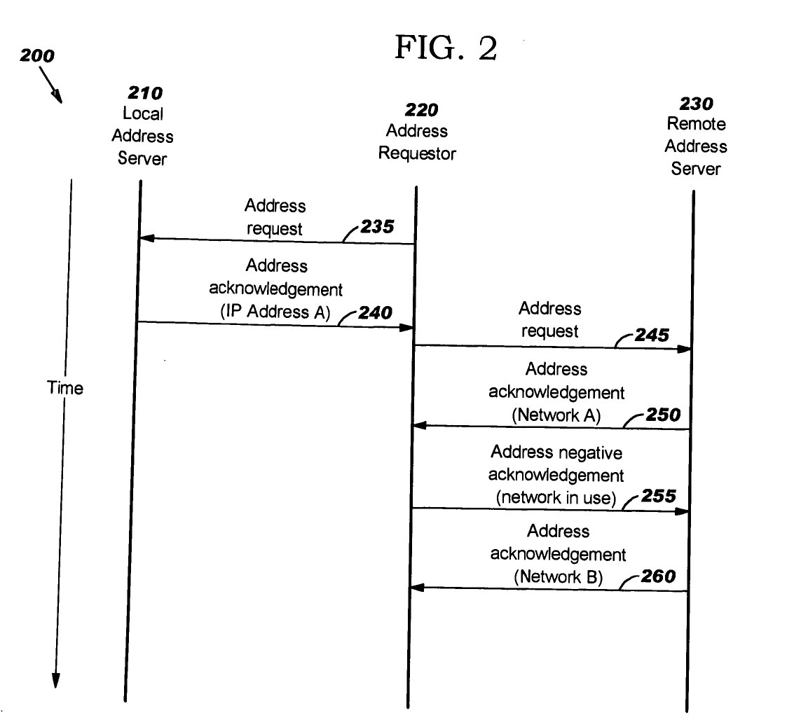

FIG. 2 is an exemplary flow diagram 200 illustrating the flow of messages in the network environment of FIG. 1 to receive an internet protocol (IP) address for a VPN session in accordance with the present invention. The local address server 210 may suitably be similar to router 120A in FIG. 1. The address requester 220 may suitably be similar to the client device 140 in FIG. 1. The remote address server 230 may suitably be similar to the VPN server 120B in FIG. 1.

In operation, the address requestor 220 sends an address request message 235 to request an IP address from the local address server 210 in order to communicate on the network serviced by local address server 210, the originating network. In a known manner, the local address server 210 sends an address acknowledgement message 240 containing IP address A. Additionally, the address acknowledgement message 240 contains a network mask or net mask indicating the network class.

It is well known in the art that a net mask may include one of three classes. The A class corresponds to a net mask of 255.0.0.0, referring to the first byte of a four byte IP address to define a network address, and allows 16,000,000 network devices or hosts to operate in an A class network. The B class corresponds to a net mask of 255.255.0.0, referring to the first two bytes of a four byte IP address to define a network address, and allows 65,534 network devices to operate in a B class network. The C class corresponds to a net mask of 255.255.255.0, referring to the first three bytes of a four byte IP address to define a network address, and allows 254 network devices to operate in a C class network. The combination of the IP address and the net mask determine the actual network address. In this example, it is assumed that a class A net mask is sent in the address acknowledgement so that the network address X is carried in IP address A.

Upon receiving IP address A, the address requestor becomes known to the originating network by other devices as having IP address A. For example, if a customer at a coffee shop walked in to browse the Internet or instant message other customers in the coffee shop, the customer's client device would initiate messages using IP address A. If the customer wants to access his or her employer's VPN, for example, target network 130B in FIG. 1, the address requestor 220 would send an address request message 245 to the remote address server 230. Although not shown in the flow diagram, the address request message 245 physically passes through the local address server 210 before arriving at remote address server 230. The remote address server 230, without knowledge of the IP addresses being used in the originating network, sends an address acknowledgement message 250 to the address requestor 220. The address acknowledgement message 250 contains, for example, an IP address B with a class A net mask resulting in a network address X contained within IP address B.

In accordance with the teachings of the present invention, the address requestor compares the network address carried in IP address B with the network address of IP address A and determines that both IP addresses are utilizing the same network address X. As a result, the address requestor 220, in one embodiment of the present invention, sends an address negative acknowledgement message 255 with a reason code of “network in use” to remote address server 230. Upon receiving the negative acknowledgement message 255, the remote address server 230 selects a different network address and sends an address acknowledgement message 260 having an IP address C with a network address Y. It should be noted that the IP address sent by the remote address server 230 need not have the same network address as the target network. Thus, the network address Y is typically different than private network address 10.10.10.0 as shown in FIG. 1.

Various techniques may be used for determining a different network address. For example, the different network address may be calculated by incrementing or decrementing the previous network address by a constant amount, by shifting left or right the previous network address by one bit, or by selecting an address from a pool of pre-defined addresses. Furthermore, the different network address may be determined by changing the net mask to a different class altogether. Server code 150, according to the teachings of the present invention, recognizes the “network in use” reason code and determines the different network address according to the previously discussed exemplary techniques or some other suitable technique. Other message flows utilizing different message names or different message fields may be used such as the CHCPREQUEST and DHCPDECLINE messages when using the DHCP protocol to achieve the same results and the present invention should not be limited to the exemplary flow described. The CHCPREQUEST and DHCPDECLINE messages are discussed in more detail in the R. Droms, RFC 2131, “Dynamic Host Configuration Protocol”, Networking Group, Bucknell University, March 1997. However, it is preferable for the address requestor to determine whether a conflict results. Client code 160, according to the teachings of the present invention, makes the determination of whether a conflict results. Otherwise, the address server would be performing needless and burdensome calculations for each address requestor attempting to connect when such a function can be easily dispersed to each individual address requestor.

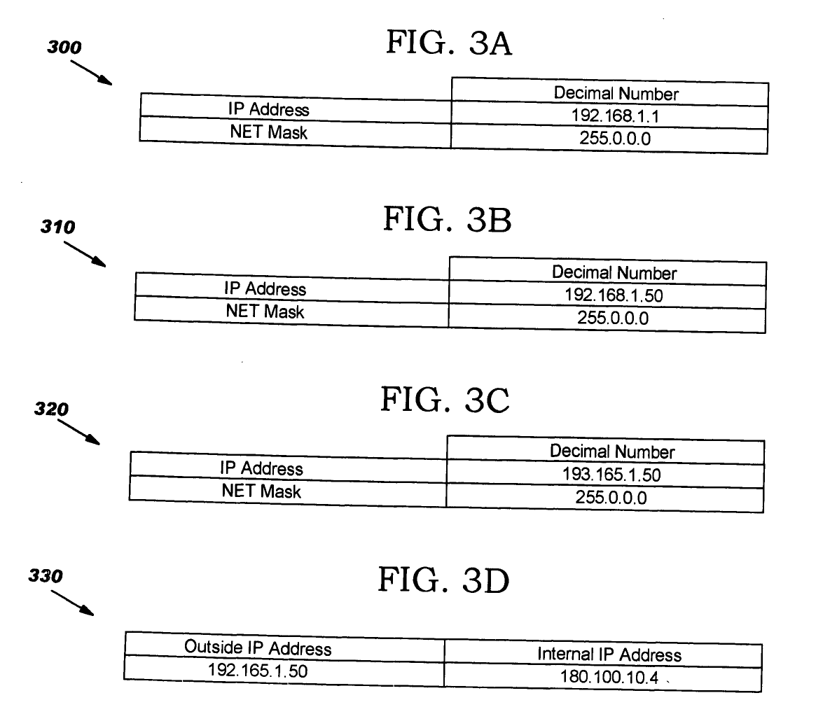

FIG. 3A is a table 300 containing an exemplary IP address and a network mask carried in the address acknowledgement 240 of FIG. 2. In the above message flow described in connection with FIG. 2, the address acknowledgement message 240 contains the IP address 192.168.1.1 and the net mask 255.0.0.0 resulting in a one byte network address 192.0.0.0.

FIG. 3B is a table 310 containing an exemplary first IP address and a network mask carried in the address acknowledgement message 250 sent from remote address server 230. In the above message flow described in connection with FIG. 2, the address acknowledgement message 250 contains the IP address 192.168.1.50 and the net mask of 255.0.0.0, resulting in a one byte network address of 192.0.0.0. The address requestor 220 in accordance with the present invention compares the network addresses received from the local address server 210 and the remote address 230 server and determines that there is a network address conflict. The address requestor 220 in accordance with the present invention sends an address negative acknowledgement message 255 with a reason code of “network in use”, for example, to the remote address server 230.

FIG. 3C is a table 330 containing a second exemplary IP address and an optional network mask carried in address acknowledgement message 260 from the remote address server 230 of FIG. 2. In the above message flow described in connection with FIG. 2, the address acknowledgement message 260 contains the IP address 193.165.1.50 and the net mask 255.0.0.0, resulting in a one byte network address of 193.0.0.0. The address requestor 220 determines that this address is a non-conflicting network address.

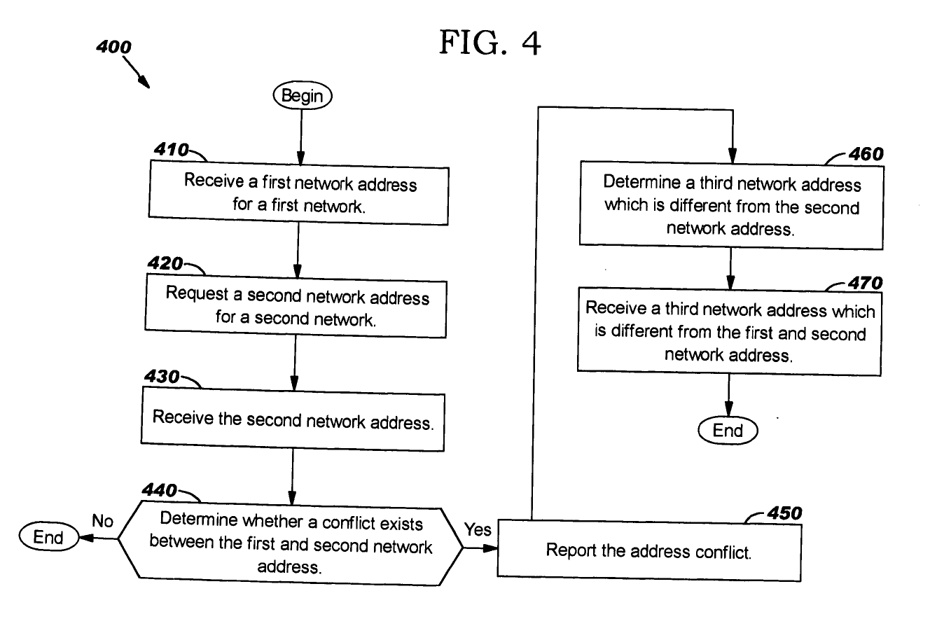

FIG. 4 is a flow chart illustrating a method of avoiding a network address collision in accordance with the present invention. Beginning at step 410, an address requestor receives a first network address for operating in a first network. Proceeding to step 420, the address requestor requests a second network address for operating in a second network. At step 430, second network address is received. At step 440, it is determined whether a conflict exists between the first and second network address. If there is no conflict, the method 400 ends and the address requestor uses the first network address to communicate on the first network and the second network address to communicate on the second network. If a conflict occurs, for example, the first and second network addresses are the same, the method proceeds to step 450. At step 450, the method reports an address conflict. This step may be implemented in various ways. In one approach a reason code is provided in an address acknowledgement message. According to another approach, an entirely new message may be sent to indicate that a conflict occurred. As a further alternative, a new field could be added to an existing address acknowledgement message.

At step 460, a third network address is determined which is different from the second network address. Proceeding to step 470, the third network address is received. Consequently, an address requestor in accordance with the present invention utilizes the third network address to communicate with the second network.

What is claimed is:

1. A system for avoiding a network address collision, the system comprising:
a server for distributing addresses for accessing a target network;
an originating network;
a computer connected to the originating network, the computer identified on the originating network with a first address, the first address having a first network address, the computer requesting a connection to the target network, the server returning a second address having the second network address to the computer in response to the computer's request, the computer comparing the first and second network addresses to determine whether there is a conflict, upon making a determination of a conflict between the first and second network addresses, the computer reporting that the second network address is in conflict.

2. The system of claim 1 wherein the server is a virtual private network (VPN) server.

3. The system of claim 1 wherein the server generates a different network address in response to the computer's report.

4. The system of claim 1 wherein the computer reports that the second network address is in conflict by defining a reason code in an address acknowledgement message.

5. The system of claim 3 wherein the server generates the different network address by selecting the different network address from a pool of pre-defined addresses.

6. The system of claim 3 wherein the server generates the different network address by performing a mathematical operation on the first address.

7. A method for avoiding a network address collision, the method comprising:
identifying a computer on an originating network with a first address, the first address having a first network address;
requesting a connection to a target network;
returning a second address having the second network address in response to the request step;
comparing the first and second network addresses to determine whether there is a conflict; and
reporting that the second network address is in conflict, upon making a determination of a conflict between the first and second network addresses.

8. The method of claim 7 wherein the requesting step further comprises requesting a connection through a virtual private network (VPN) server.

9. The method of claim 7 further comprising:
generating a different network address in response to the reporting step.

10. The method of claim 7 wherein the reporting step further comprises defining a reason code in an address acknowledgement message.

11. The method of claim 9 wherein the generating step further comprises selecting the different network address from a pool of pre-defined addresses.

12. The method of claim 9 wherein the generating step further comprises performing a mathematical operation on the first address to determine the different network address.

13. A computer readable medium whose contents cause a computer system to avoid a network address collision, the computer system having a client program and a server program, the computer system performing the steps of:
identifying a computer on an originating network with a first address, the first address having a first network address;
sending a request for a connection to a target network by the client program;
receiving a second address having the second network address at the client program in response to the request;
comparing the first and second network addresses by the client program to determine whether there is a conflict; and
reporting to the server program that the second network address is in conflict, upon making a determination of a conflict between the first and second network addresses.

14. The computer readable medium of claim 13 wherein the sending step further comprises requesting a connection through a virtual private network (VPN) server.

15. The computer readable medium of claim 13 further comprising:
generating a different network address by the server program in response to the reporting step.

16. The computer readable medium of claim 13 wherein the reporting step further comprises defining a reason code in an address acknowledgement message.

17. The computer readable medium of claim 15 wherein the generating step further comprises selecting the different network address from a pool of pre-defined addresses.

18. The computer readable medium of claim 15 wherein the generating step further comprises performing a mathematical operation on the first address to determine the different network address.
